(19) United States
(12) Patent Application Publication
(10) Pub. No.: US 2013/0156274 A1
(43) Pub. Date: Jun. 20, 2013

(54) USING PHOTOGRAPH TO INITIATE AND PERFORM ACTION

(71) Applicants: Daniel Buchmueller, Seattle, WA (US); Amir Akbarzadeh, Oakland, CA (US); Michael Kroepfl, Bellevue, WA (US)

(72) Inventors: Daniel Buchmueller, Seattle, WA (US); Amir Akbarzadeh, Oakland, CA (US); Michael Kroepfl, Bellevue, WA (US)

(73) Assignee: MICROSOFT CORPORATION, Redmond, WA (US)

(21) Appl. No.: 13/329,327

(22) Filed: Dec. 19, 2011

(51) Int. Cl. G06K 9/00

(52) U.S. Cl. 382/118

(57) ABSTRACT

Actions, such as adding new connection to a social graph, may be performed through picture taking. In one example, a user takes a picture of one or more people. The face in the picture may be sent to a social network for identification. The social network may use various resources to identify the face, including the social network's picture database and its social graph. When the person in the picture has been identified, the user may indicate an action (e.g., “adding as a friend” in a social network) to be performed with respect to the identified person. The action requested by the user may be then performed with respect to the identified person.

### BACKGROUND

Social networks typically allow users to identify their relationship to other people, as in the case of friend relationships on Facebook, or “following” relationships on Twitter. In order to identify these relationships, a user typically identifies, by name, the person he or she wants to form a relationship with, either by searching for that person by name, or by recognizing the name when the name is shown to the user. However, a user might meet people whose name he or she does not know. For example, one might meet a person at a party or other event without finding out the person's name.

Additionally, social networks typically have a large database of tagged photographs. Using face detection, it is possible to receive an image of a face and to determine possible identities of the person shown in the image, by comparing the face with tagged photographs. However, social networks generally use such face matching techniques mainly to suggest possible tags for faces in a new photograph, or to auto-tag the photograph.

### SUMMARY

A person may participate in a social network by using photographs to identify the target of actions such as friend requests, messages, invitations, etc. A person uses a device, such as a wireless phone equipped with a camera, to take pictures of people. The photograph may be analyzed to identify faces in the photograph. The device may present, to the user, an interface that allows the user to take some action with respect to a person shown in the photograph. For example, the interface may allow the user to “friend” a person shown in the photograph.

Before a user requests to perform an action with respect to a person shown in the photograph, the photograph containing faces (or a representation of the faces) is uploaded to a social network server (or to an intermediary service that queries one or more social network services). The server maintains a social graph (e.g., the graph of users on the Facebook service, where edges in the graph represent friend relationships), and may also have photographs of users in the social graph. The social network server may also have software that selects one or more candidate identities of the person in the social graph, using various types of reasoning. For example, the software may choose candidate identities based on the similarity between the face in the photograph and the candidates, the social distance between the candidate(s) and the person who is uploading the photograph, the time and place at which the photograph was taken, the workplaces and ages of the candidates, the identities of other people who appear in the photograph, the identities of people attending the same event subscribed to on a social network, or any other appropriate factors. Based on this reasoning, the software may identify one or more candidate faces. If one candidate face is identified with sufficiently high certainty, then the user's request may be carried out—e.g., a friend request may be made from the user to the candidate. If there are two or more candidate faces, then the user may be asked to choose from among the candidates, either by the candidates' names, or by their public profile pictures (e.g., in the case where the candidates' privacy settings allow their public profile pictures, but not their names, to be used). The user may then select an action to be performed with respect to the identified user, or may select from a menu of actions to be carried out. The requested action may then be carried out for the selected candidate.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which a user uses a picture to perform an action.

FIG. 2 is a block diagram of the detail of an example social network server.

FIG. 3 is a flow diagram of an example process in which a user may use a picture of a person to initiate and/or perform an action with respect to that person.

FIG. 4 is a block diagram of example components that may be used in connection with implementations of the subject matter described herein.

### DETAILED DESCRIPTION

Social networks allow users to specify their relationship to other users. For example, Facebook “friend” relationships are an example of bidirectional relationships between people. As another example, Twitter “following” relationships are examples of unidirectional relationships between people. Richer information about relationship between people may also be collected. For example, in Facebook the basic relationship between two users is the “friend” relationship, but people can also specify that they are relatives of each other. Moreover, Facebook has non-user entities (e.g., political parties, television shows, music groups, etc.,) which may not be “friendable” but that users can indicate their affinity for by “liking” these entities. Information about who is friends with whom, who likes which entities, who is relatives with whom, who is following whom, etc., forms a complex social graph that provides detailed information about the relationships among people and entities in the world.

One type of information that social network services typically collect is photographs. People often choose to upload photographs to social networks as a way of sharing those photographs, and may also tag the people in the photograph. Tagged photographs provide a large amount of information about what specific people look like. This information can be used with a face detection algorithm to identify a face in an untagged photograph, by comparing the face in a new photograph with known faces from previously-tagged photographs.

Social networking sites may provide some type of tagging service based on face detection. For example, if a user submits or uploads a new, untagged photo, the site may examine the photo to determine how similar the faces in the photo are to faces that have been tagged in the user's photo, or in the user's friends' photos, etc. The site may then automatically tag the new photo if it has a sufficient level of confidence that it has identified a face in the photo. Or, if the site has identified one or more candidates but does not have a sufficiently-high level of confidence in any particular candidate, then the site might suggests one or more possible identities of a person shown in the photo and ask the user to confirm or select an identity from among the candidates. However, such sites tend to suffer from at least two deficiencies. First, they often limit the use of face detection to helping a user tag photos. Second, they tend to be helpful when a new photo contains people who have already appeared in the user's photos, but are less helpful at identifying people who are unknown to the user.

The subject matter described herein uses photos as a way of identifying the target of an action. A user may start the process by taking, or uploading, a photo that contains people. The photo may then be analyzed to identify faces in the photo. With respect to each face in the photo, a user may be offered the chance to perform some action with respect to that user. For example, the user might be offered the chance to add a person in the photo as a friend, or to send the person a message, or to view the person's profile (if the appropriate permissions allow the requesting user to view the profile), or to send the person an invitation, or send a Facebook-type “poke” to the user, or to perform any other appropriate action.

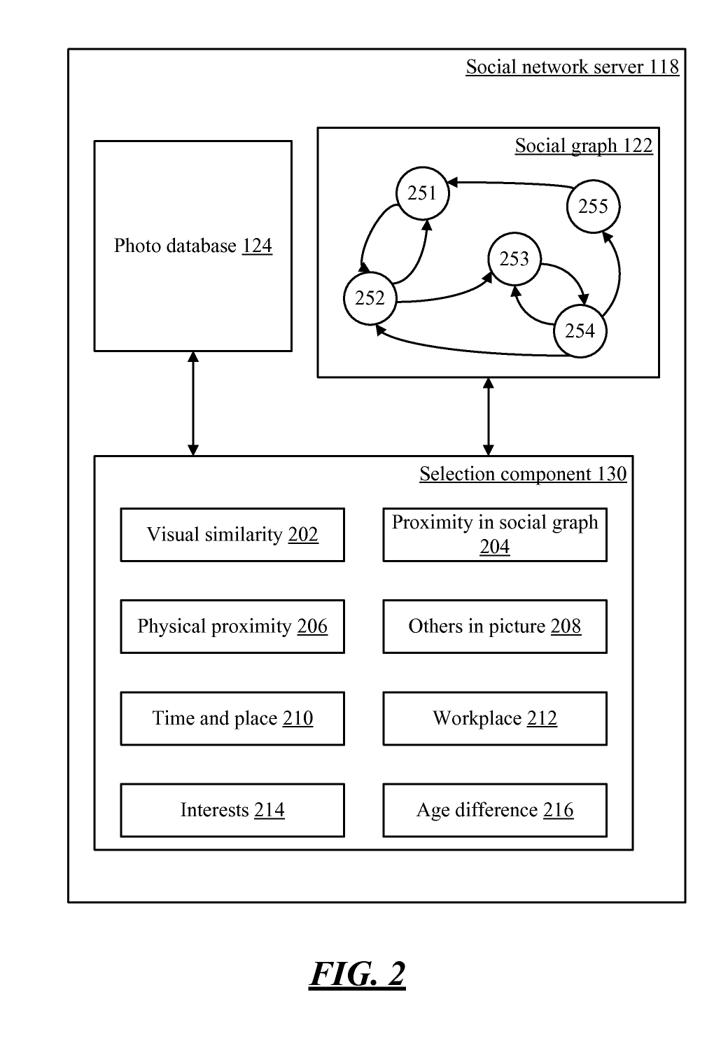

In order to make the foregoing happen, the photo (or parts of the photo, such as the regions of the photo that contain faces, or metadata calculated on a client defines that represents facial features) may be uploaded to a social networking server (where “uploading to a social networking service” includes the act of uploading to a service that acts as an intermediary for one or more social networks by forwarding information to one or more social networks or by exposing the social graph of the one or more social networks). The social networking server may maintain certain types of information that allows it to assist the user with the request. For example, the social networking server may maintain a social graph of its users, indicating relationships among the users. Additionally, the social networking site may maintain a set of tagged photos, which provides a set of identified faces that can serve as exemplars for a face matching process. (In order to preserve a user's interest in privacy, a user may be given the chance to determine whether the user is willing to have photos of his face used for face matching purposes.) In addition to the photos being tagged with the identities of people who appear in them, the photos may also have been tagged with information such as the time and/or place at which the photo was taken. Moreover, the social networking site may maintain information about its users, such as their ages, city of residence, workplace, affiliations, interests, or any other appropriate information. (Since some of the information mentioned above may be considered personal to the user, a social networking site may maintain this information pursuant to appropriate permission obtained from the user. Additionally, in order to protect the user's privacy, there may be controls on how such information may be used.) The social networking site may have a component that uses the information contained in the social graph and the photo database to identify the target of a request. The component may use the information in the social graph and photo database in various ways, which are discussed in detail below, in connection with FIG. 2.

Once a person has been identified, the social network server may return one or more candidate identities to the user's device. If there is only a single candidate identity that has been identified with a sufficiently high level of confidence for each face, then software on the user's computer or other device may simply accept the identity and offer the user the chance to perform an action with respect to that person. On the other hand, if the social network server cannot identify any person with a sufficiently high level of confidence, then it might return a list of one or more candidates to the user's device, and the user's device might ask the user to confirm the choice, or to select among possible choices. Once the user has made the confirmation or selection, that person may become the target of a request. The user may then be allowed to enter a requested action, or may be offered a set of possible actions from a menu. Once the user indicates an action, the requested action is performed with respect to the target person. The way in which a person's identity is used for the foregoing process may be limited by the person's privacy settings. For example, a person may decline to allow himself to be the target of requests that identify the person by photograph, or may disallow his name or profile picture from being made known to someone he is not friends with, or may allow only his public profile picture (but not his name) to be used. For example, if a person allows only his public profile picture but not his name to be used, then the profile picture (but not the name) would be used to identify that person in a disambiguation request. It is also noted that the set of actions that might be performable with respect to a person may be limited based on who is identified as the person in a photo. For example, there might be two candidates, A and B, who are possible identities of a person in a photo. A might allow himself to be friended based on picture identified, while B might not. If the user disambiguates the choice by choosing A, then a friend request might be offered as an option, while a friend request would not be offered as an option if the user disambiguates by choosing B.

It is noted that systems that automatically provide tags (or suggested tags) for photos are different from, and are not obvious in view of, systems that make a connection in a social graph between a person and a target that is identified by a picture. The former case is merely face detection, while the latter case uses the identity of a face to extend a social graph. Moreover, it is noted that systems that allow a user to specify the target of a friend request by entering the target's name in the form of text are not the same as, and are not obvious in view of, systems that allow users to specify the target by using a photograph of that target.

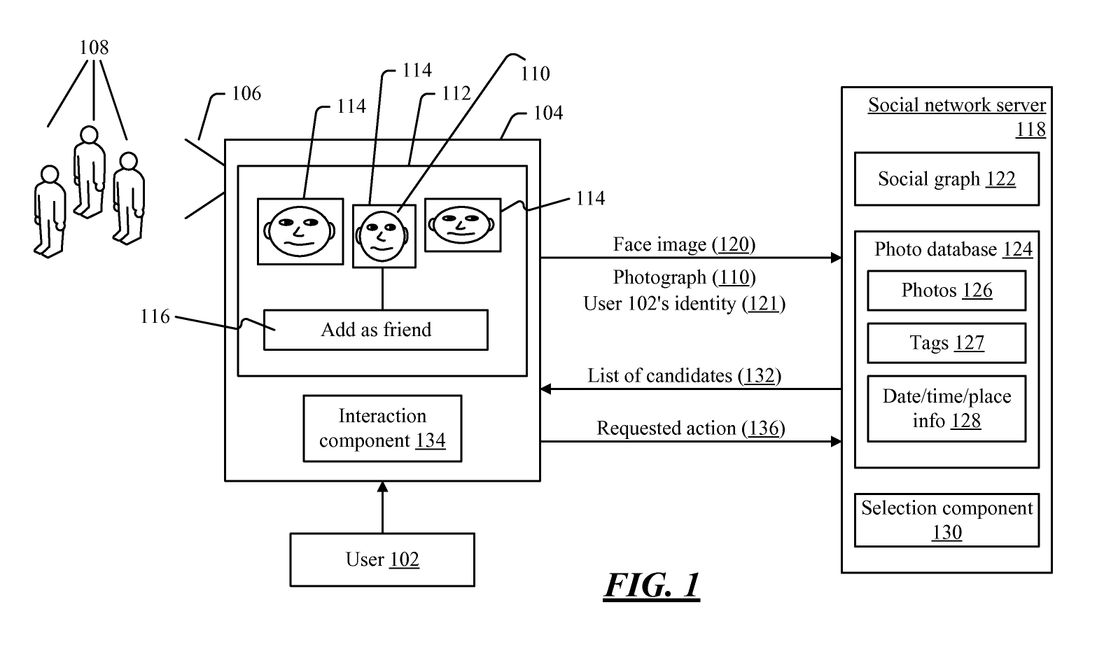

Turning now to the drawings, FIG. 1 shows an example scenario in which a user uses a picture to perform an action. In the example shown, user 102 has a device 104. Device 104 may be a wireless telephone, a handheld computer, a music player, a tablet, or any other type of device. Device 104 may be equipped with camera 106, which allows user 102 to take pictures with device 104. (In one example, device 104 may be a standalone camera.) User 102 takes a picture of people 108. User 102 may be one of people 108; or, alternatively, people 108 may be a group of people that does not include user 102. The photograph 110 that is taken may appear on a screen 112 of device 104. A component on device 104 (e.g., a software component) may detect the faces 114 that appear in photograph 110. (Techniques are generally known by which software can analyze and image and determine which portions of the image are faces.)

Device 104 may then upload photograph 110 (or data that represents photograph 110, such as extracted rectangles that contain the faces, or data that quantifies and represents facial features in order to facilitate face recognition) to social network server 118. (As noted above, the act of “uploading to a social network server” includes, as one example, the act of uploading to an intermediary server either forwards information to a social network server, or that exposes the social graph maintained by a social network server). The information that is uploaded may include all of photograph 110, one or more face images 120 (or metadata representing face images), and may also include user 102's identity 121.

Social network server 118 may comprise software and/or hardware that implement a social networking system. For example, the set of machines and software that operate the Facebook social networking server are an example of social network server 118. (Although the term “social network server” is singular, that term may refer to systems that are implemented through a plurality of servers, or any combination of plural components.) Social network server 118 may maintain a social graph 122, which indicates relationships among people—e.g., who is friends with whom, who follows whom, etc. Additionally, social network server may maintain a photo database 124, which contains photos 126 that have been uploaded by users of the social network. Additionally, photo database 124 may contain various metadata about the photos. The metadata may include tags 127 that have been applied to the photos (indicating who or what is in the photo), date/time/place information 128 indicating where and when the photos were taken, or any other information about the photos. Social network server 118 may also have a selection component 130, which comprises software and/or hardware that identifies one or more candidates who may be the target of user 102's request. Selection component 130 may make this identification in various ways—e.g., looking for photos of known users who look similar to the request target, by looking for people with a low social distance to the requesting user 102, by looking for people who are similar in age to the requesting user 102, by looking for people who work at the same place as user 102, by looking for people who are known to have been in the place in which requesting user's photo was taken at the time that the photo was taken, or by any other appropriate mechanism.

When selection component has identified one or more candidate identities, a list 132 of candidates is provided to device 104 for one or more of the people who appear in the photograph. User 102 may then be able to indicate with person he would like to perform an action for. For example, screen 112 may be a touch screen, and the user may tap on a face to indicate that he would like to perform an action with respect to the person to whom that face belongs. If there is only one candidate identity for that face, then user 102 may enter an action to be performed for that user, or may be shown a menu of possible actions. (As noted above, the actions on the menu may be affected by the target user's privacy settings—e.g., a user may allow certain actions but not other to be performed based on face recognition.) If there are two or more candidates for a face, then user 102 might be asked to select among these candidates (where the candidates might be shown by their name and/or public profile picture, depending—again—on the privacy settings of the target person). In one variation, selection component 130 identifies two or more candidates but has a high level of confidence in one of the selections; in this case, user 102 might be presented with a choice in which the higher-confidence candidate is “pre-selected”, but in which the user is asked to either confirm the pre-selection, or to change the selection to one of the other candidates. Device 104 may have an interaction component 134, which may comprise software and/or hardware that interprets the user's gestures or other actions as an indication that the user wants to make a request with respect to one of the faces in the photograph, sends the relevant information to social network server 118, asks the user to choose among several possible candidates where applicable, and performs any other actions on device 104 relating to the use of a photograph to initiate and/or perform an action. For example, when the user taps on one of the faces shown on screen 112, it may be interaction component 134 that displays the “add as friend” message shown in FIG. 1. Whatever action 136 the user requests may then be sent to social network server 118 (which, as noted above, may be performed through an intermediary).

FIG. 2 shows detail of an example social network server 118. As described above in connection with FIG. 1, social network server 118 may maintain a social graph 122, a photo database 124, and a selection component 130. Selection component 130 may identify one or more candidates for the target request, and may do so based on various factors. The application of these factors may be made based on information contained in social graph 122 and/or photo database 124. Photo database 124 may contain photos and metadata, as described above.

Social graph 122 may contain data that shows relationships among people. As a simple example, FIG. 2 shows social graph 122 as having five people 251, 252, 253, 254, and 255, who are shown as nodes in the graph. Edges between the nodes (which are shown as arrows connecting the circles) indicate relationships between the nodes. Each arrow might be interpreted as a “friend” relationship, a “following” relationship, a “relative” relationship, a common “like” relationship (e.g., two people who have “liked” the same page in Facebook), or any other kind of relationship that could be recognized. Given such a graph, it is possible to define social proximity and/or distance between two people. For example, person 255 has a distance of two from person 252, because it is possible to reach person 252 from person 255 by traversing two edges (by going through person 251). This fact might indicate that person 252 is a “friend of a friend” of person 255 (or, perhaps, a “follower of a follower”, depending on how the edges are interpreted). Direction of an edge might be considered, or disregarded, in determining the distance and/or existence of a relationship. For example, although person 252 has distance two from person 255, if direction of the edges is considered, then person 252 has no relationship to person 255, since it is not possible to reach person 255 from person 252. (In other words, when direction is considered, it is possible for A to have a relationship with B even if B has no relationship with A.) If direction of the edges is disregarded, then person 255 and person 252 have a relationship with each other of degree two.

Examples of factors that may be considered by selection component 130 are shown in FIG. 2, in the boxes within selection component 130.

One example factor that may be considered is visual similarity (block 202) between the person who is the target of the request and people in photo database 124. When a user requests to perform an action with respect to a target, an image of the target's face may be provided to selection component 130. (The face may be provided to selection component 130 by providing the source photograph that contains the face, by extracting the region that contains the face and providing that region, or by extracting data that quantifies facial features.) Face matching algorithms may be used to compare the face of the request target with people whose faces appear in photo database 124. The actual identities of people in photo database 124 may be known through tags that have been previously applied to those photos. Visual similarity between two faces may be a relatively strong indication that the faces are of the same person.

Another example factor that may be considered is proximity in the social graph (block 204). For example, the user who submits a request is more likely to know people who are close to him or her in the social graph—e.g., an existing friend, a friend of a friend, friend of a friend of a friend, someone who has liked the same page, etc. Someone who has no relationship to the user, or only a distant relationship, might be less likely to be the target of a request than someone who is close to the user. The foregoing example considers social proximity to the requesting user, but social proximity from some other reference point could be considered. For example, person A might take a photograph, and person B might use that photograph to identify the target of a request that person B is making. In this case, social distance might be measured either from the person who took the photograph or from the person who is making the request. A person might be more likely to take a picture of someone who has a low social distance to the photographer, so the search for candidates might focus either on people with a low social distance to the requester, or people with a low social distance to the photographer. (The term “requester” will be used herein to refer to the user who is requesting to perform an action with respect to someone that the user has identified by way of a photo—e.g., the user who taps a face to make an “add as friend” request, as shown in FIG. 1.)

Another factor that may be considered is physical proximity—either to the photographer or to the requester (block 206). A requester might be more likely to submit certain types of requests (e.g., friend requests, invitations, etc.) to people who live near that requester. Additionally, a photographer might be more likely to take a picture of someone who lives near the photographer. While a candidate's physical proximity to the requester or photographer might tend to weigh in favor of that candidate, there are countervailing considerations. For example, the requester and/or photographer might be on vacation. Moreover, many actions (e.g., adding a friend on a widespread social network, sending an e-mail message, etc.) might not be a geographically-limited activity. If face matching suggests very strongly that a particular candidate is the person shown in a photo, the fact that the candidate lives far away from the requester or photographer might not be sufficient to override a finding based on face matching. Thus, like all of the factors described herein, physical proximity is merely one consideration that could be overridden by other considerations.

Another factor that may be considered is other people in the same picture (block 208). A picture that is used to initiate a request to perform an action may have several people. One of those people may be the target of the action, while the others might not be. People may be more likely to appear in photos with others whom they know. Thus, if face matching identifies a particular person as being the request target, but that person (according to social graph 122) has no known connection to anyone else in the photo, that fact might suggest that the face match has identified the wrong person. However, it is possible for a person to appear in a photo with others whom he does not know so—like the other factors described herein—connection (or lack thereof) to others in the same photo is merely one consideration to be used in identifying a candidate. Additionally, it is noted that any of the information mentioned at blocks 202-216 can be considered for the others in the photo—e.g., those people's position in the social graph, their interests, their workplaces, etc., although information about a person might have less influence on the identification process depending on how far remove that person is from the person to be identified. E.g., the workplace affiliations of the person to be identified might have a strong influence on identifying that person; the workplace affiliations of people who appear in the photograph with that person might have some influence, but less influence that then workplace affiliations of the target person.

Another factor that may be considered is the time and place at which the photo was taken (block 210), and the times and places where people were known to be. If a person was known to be somewhere other than where the photo was taken, at the time at which the photo was taken, this fact makes it unlikely that the person actually appears in the photo. Thus, if a person in a photo is identified by a face match, but it is then determined that the person was not in the location of the photo at the time the photo was taken, the person may be removed as a candidate. Information about where a person was, and when he or she was there, might be determined from information contained in social graph 122 and/or photo database 124. For example, a photo may have metadata indicating when and where it was taken. The whereabouts of a given person might be determined from various information—e.g., self-reporting (such as when a plurality of users indicate in advance that they will attend the same event), time and place associated with that person's posts, metadata associated with photos the person has taken, etc. (In order to preserve a person's interest in privacy, information about a person's whereabouts may be used in accordance with appropriate permission obtained from that person.)

Other factors that might be considered are workplace (block 212), interests (block 214), and age (block 216). People who work in the same place, have similar interests, or who are similar in age might be more likely to be the targets of each other's requests. Like the other factors described herein, these considerations are subject to countervailing interests. For example, a user might meet a much older person at a business conference, and might still want to send a friend request or e-mail message to that person. However, workplace, common interests, and age are factors that may be taken into account in determining who, in a photo, is the target of a request. Information about workplace, interests, and age might be available in social graph 122. With regard to age, it is noted that age might be treated differently for minors than for adults. For example, using minors as possible face match results might be disallowed entirely, or might be restricted to face matches initiated by other minors. Or, in another example, minors might be restricted from using face matches to identify people they do not know.

In addition to the considerations noted above, any other appropriate information could be used as a consideration—e.g., whether users have the same taste in music, like the same food, or any other information suggesting commonality (or differences) between people in the social graph. In general, all other factors being equal, users who have an item in common with each other would be considered more likely to appear in a photograph together. Moreover, all other things being equal, it would be considered more likely that a user would take or upload a photograph of someone who has something in common with the user than someone who has nothing in common with the user.

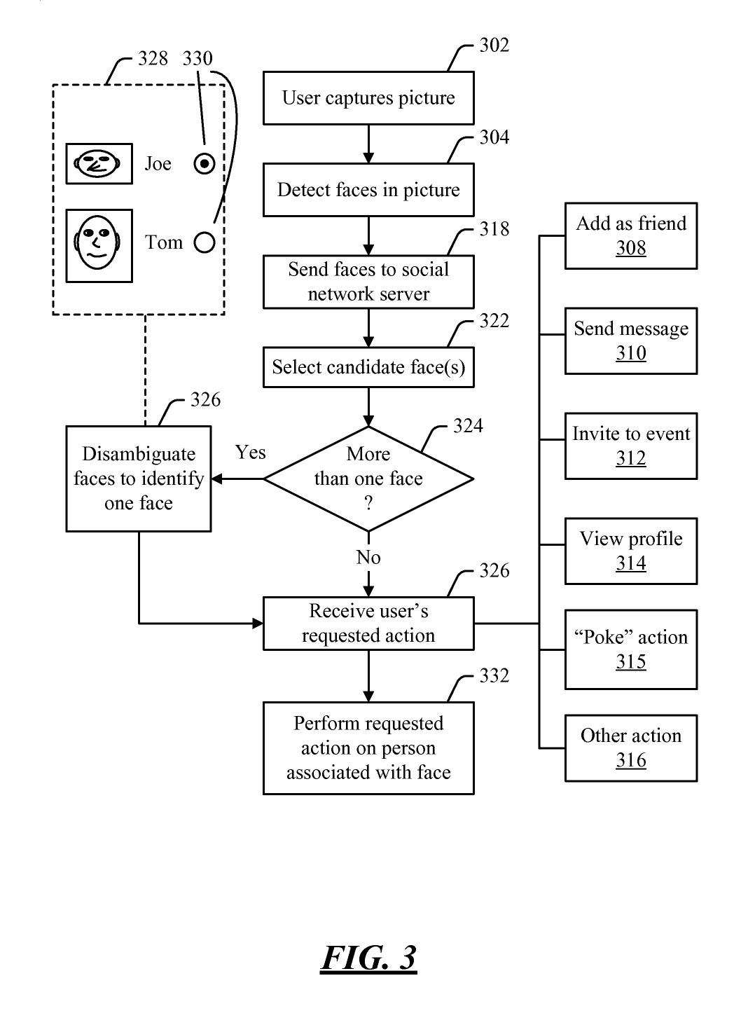

FIG. 3 shows an example process in which a user may use a picture of a person to initiate and/or perform an action with respect to that person. Before turning to a description of FIG. 3, it is noted that the flow diagram of FIG. 3 is described, by way of example, with reference to components shown in FIGS. 1 and 2, although the process of FIG. 3 may be carried out in any system and is not limited to the scenarios shown in FIGS. 1 and 2. Additionally, the flow diagram in FIG. 3 shows an example in which stages of a process are carried out in a particular order, as indicated by the lines connecting the blocks, but the various stages shown in this diagram can be performed in any order, or in any combination or sub-combination.

At 302, a user may capture a picture. For example, the user may carry a wireless telephone equipped with a camera, and may take a picture with that camera. At 304, people in a picture are detected. For example, a face detection algorithm may be applied to the picture to detect which regions of the picture contain people's faces. It is noted that “detection” of faces, at this stage, does not imply knowledge of whose face appears in the picture. Rather, detection of a face in the act performed at 304 refers to the act of distinguishing those regions of a picture that contain faces from those regions that do not contain faces. (Detection of face can be performed either on the client or on the server.) Moreover, it is noted that the picture to which face detection is applied may be a picture that was captured by the user's camera, but could also be a different picture, captured at a different point in time, and/or at a different place, and/or by a different person. For example, a user might carry a wireless telephone, but might acquire a photo (e.g., via Multimedia Messaging Service (MMS), via WiFi upload, etc.), and might use that photo in the process described in FIG. 3, as if the photo had been taken by the user. The subject matter herein is not limited to the scenario in which the user takes the photo with his or her own device, and then uses that device to perform an action; rather, the photo can come from anywhere.

At 318, representations of the faces of the people in the photograph are sent to a social network server. In one example, the entire photograph may be sent to the social network (along with some indication of which face in the photograph is the target of the request). In another example, the faces may be extracted from the photograph, and may be sent separately. In yet another example, metrics that represent facial features may be calculated, and those metrics may be sent.

At 322, candidate faces are selected. The process of selecting candidate faces may be performed by selection component 130 (described above in FIGS. 1 and 2), and may be performed using the various types of selection factors described above in connection with FIG. 2. The selection process may produce, for each face, a single candidate, or may produce a plurality of candidates. The candidate(s) may be sent to the device on which the user initiated a request. If there is more than one candidate (as determined at 324), then a disambiguation process may be performed at 326. For example, a user may be presented with an interface 328 that allows him to pick between two candidate identities (Joe and Tom, in the example in FIG. 3) by using radio buttons 330 to choose one of the candidates. In the example shown, the user is shown the names of the candidates; however, as noted above, based on the privacy settings of the candidates, a user might be shown the candidate's public profile picture instead of his name.

Once the selection of candidates has been disambiguated (or if it is determined at 324 that there is only one candidate), then a requested action may be received from a user (at 326). The user may enter the requested action, or may select the action from a menu. Some example actions that could be requested (either by default, or through as a result of a user's selecting from among a plurality of actions) are: adding the person as a friend (block 308), sending a message to the person (block 310), inviting the person to an event (block 312), or viewing the person's profile on a service (such as Facebook) that maintains profiles (block 314), or “poking” that person using an action such as the Facebook “poke” action (block 115). Alternatively, any other action could be requested (block 316). The requested action may then be performed with respect to the target user (at 332). For example, if a user indicated that he wants to add a particular user shown in a photograph as a friend, then a friend request may be sent to that user.

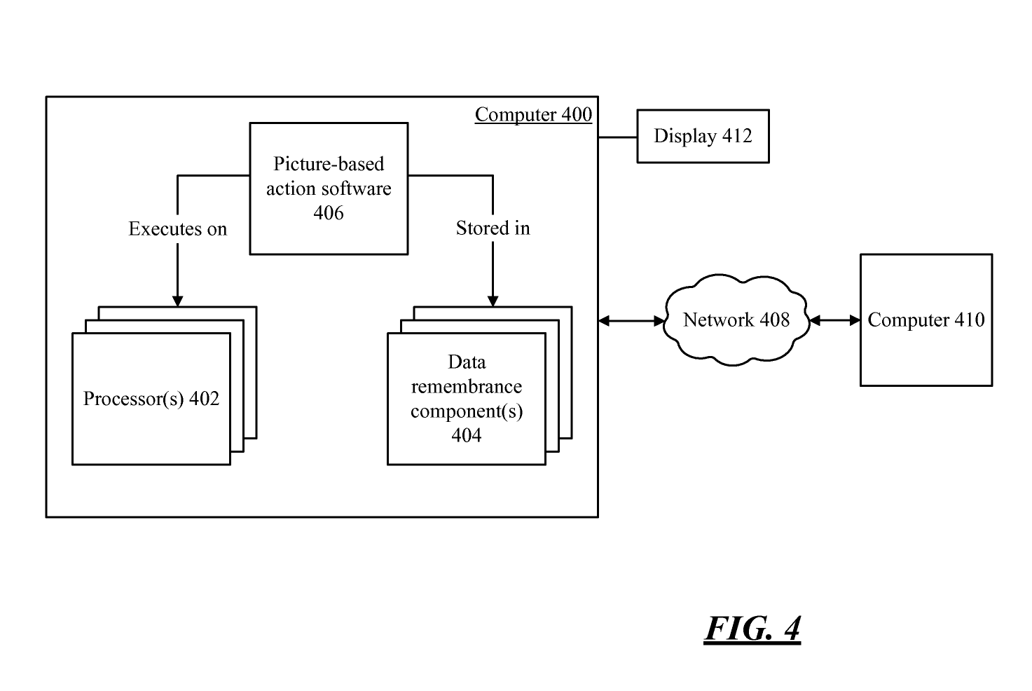

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is picture-based action software 406, which may implement some or all of the functionality described above in connection with FIGS. 1-3, although any type of software could be used. Software 406 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium. The term “computer-readable media” does not include signals per se; nor does it include information that exists solely as a propagating signal. It will be understood that, if the claims herein refer to media that carry information solely in the form of a propagating signal, and not in any type of durable storage, such claims will use the terms “transitory” or “ephemeral” (e.g., “transitory computer-readable media”, or “ephemeral computer-readable media”). Unless a claim explicitly describes the media as “transitory” or “ephemeral,” such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form; such “hardware media” or “tangible media” are not signals per se. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 402) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 400 may be communicatively connected to one or more other devices through network 408. Computer 410, which may be similar in structure to computer 400, is an example of a device that can be connected to computer 400, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium having executable instructions to initiate an action with a picture, the executable instructions, when executed by a computer, causing the computer to perform acts comprising:
receiving, from a user, an indication of a face in a photograph;
sending information that represents said face to a server that operates said social network, said server identifying one or more candidates of said face;
receiving a list of said one or more candidates from said server;
based on said list of candidates, receiving a request from said user to add a person associated with said face as a connection in a social network; and
adding a first one of said one or more candidates as a connection of said user in said social network.

2. The computer-readable medium of claim 1, said server using a photo database stored at said server to identify said candidates based on visual similarity of said face to faces stored in said photo database.

3. The computer-readable medium of claim 1, said server maintaining a social graph of relationships between users of said social network, said server using said social graph to identify said candidates based on social distance between said candidates and said user, or between said candidates and a photographer who took said photograph.

4. The computer-readable medium of claim 1, said server maintaining data on locations of users of said social network, said photograph being associated with metadata that indicates a place and time at which said photograph was taken, said server identifying said candidates based on whether said candidates were at said place at said time.

5. The computer-readable medium of claim 1, said server maintaining a social graph of relationships between users of said social network, said social graph indicating a workplace, an interest, and an age for each of the users of said social network, said server identifying said candidates based on comparing of said candidates' workplaces, interests, and ages with workplaces, interests, and ages of users in said social graph.

6. The computer-readable medium of claim 1, said acts further comprising:
sending an e-mail to said first one of said candidates based on said first one of said candidates having been identified by said server as one of said candidates.

7. The computer-readable medium of claim 1, said acts further comprising:
inviting said first one of said candidates to an event based on said first one of said candidates having been identified by said server as one of said candidates.

8. The computer-readable medium of claim 1, said computer being a handheld device of said user, said device comprising a camera, said acts further comprising:
using said camera on said device to capture said photograph.

9. A method of identifying a request target based on a picture, the method comprising:
using a processor to perform acts comprising:
receiving, from a user, an image of a first face in a photograph ;
using said first face, said social graph, and a photo database to identify one or more candidates in said social graph as being said target person;
providing a list of said candidates to a device of said user;
based on a fact that a first one of said candidates was identified as being one of said candidates based on said first face, and not based on said user's having identified said first one of said candidates using text, receiving a request by said user to add a connection to a target person in a social graph; and
adding, to said social graph, a connection between a first one of said candidates and said user.

10. The method of claim 9, identifying of said one or more candidates being based on visual similarity between said first face and faces stored in said photo database.

11. The method of claim 9, said identifying of said one or more candidates being based on social distance between said candidates and said user.

12. The method of claim 9, said photograph having been taken by a photographer other than said user, said identifying of said one or more candidates being based on social distance between said candidates and said photographer.

13. The method of claim 9, said acts further comprising:
maintaining data on physical locations of people in said social graph, said photograph being associated with metadata that indicates a place and time at which said photograph was taken, identifying of said one or more candidates being based on whether said candidates were at said place at said time.

14. The method of claim 9, said social graph indicating relationships between people, said social graph indicating a workplace, an interest, and an age for each of said people, identifying of said one or more candidates being based on comparing of said candidates' workplaces, interests, and ages with workplaces, interests, and ages of said people in said social graph.

15. The method of claim 9, said device being a handheld device of said user, said device comprising a camera, said photograph having been captured by said user using said camera.

16. The method of claim 9, said receiving of said first face comprising receiving of said photograph, said photograph containing said first face and one or more second faces, identifying of said one or more candidates being based relationships between an identity associated with said first face and identities associates with said one or more second faces.

17. A system for identifying a request target based on a picture, the system comprising:
a memory;
a processor;
a social graph that defines relationships among people in a social network;
a photo database that stores photographs and metadata relating to said photographs; and
a component that is stored in said memory and that executes on said processor, that receives a photograph containing a first face and one or more second faces, that uses said first face, said social graph, and said photo database to identify one or more candidates in said social graph as being said target person, that provides providing a list of said candidates to a device of a user, that receives, from said user a request to add a connection between said user and said target person in said social graph, and that adds to said social graph a connection between a first one of said candidates and said user based on a fact that a first one of said candidates was identified as being one of said candidates based on said first face, and not based on said user's having identified said first one of said candidates using text.

18. The system of claim 17, said component identifying said one or more candidates based relationships between an identity associated with said first face and identities associates with said one or more second faces.

19. The system of claim 17, said component identifying said one or more candidates based on social distance between said candidates and said user, or between said one or more candidates and a photographer who took said photograph.

20. The system of claim 17, said social graph maintaining data on physical locations of people in said social graph, said photograph being associated with metadata that indicates a place and time at which said photograph was taken, said component identifying said one or more candidates based on whether said candidates were at said place at said time
